(19) United States
(12) Patent Application Publication
(10) Pub. No.: US 2019/0085934 A1
(43) Pub. Date: Mar. 21, 2019

(54) TORSIONAL VIBRATION DAMPER WITH LOW ELASTOMER CONTENT

(71) Applicant: Suhale Manzoor, Plymouth, MI (US)

(72) Inventor: Suhale Manzoor, Plymouth, MI (US)

(73) Assignee: Optimized Solutions, LLC, Plymouth, MI (US)

(21) Appl. No.: 16/134,195

(22) Filed: Sep. 18, 2018

Related U.S. Application Data
(60) Provisional application No. 62/561,334, filed on Sep. 21, 2017.

(51) Int. Cl. F16F 15/126

(52) U.S. Cl. CPC F16F 15/126; F16F 2224/025; F16F 2238/04; F16F 2232/02; F16F 2234/02; F16F 2226/045

(57) ABSTRACT

The disclosed invention is a Torsional Vibration Damper (TVD) that employs the use of two novel features namely the receiving ledge and the guiding ledge that allows it to have the following four advantages over conventional TVDs: (1) a reduced volume of elastomer; (2) a narrower axial thickness; (3) enhanced performance due to increased real-estate for the ring; and (4) an ability to be assembled without elaborate fixturing or bonding; while not compromising its structural and modal stability.

### FIELD OF INVENTION

The present invention generally relates to a device for attenuating torsional vibrations inherent to certain rotating shafts. The invention addresses a long-standing need for a torsional vibration damper with: (1) a reduced volume of elastomer; (2) a narrower axial thickness; (3) enhanced performance due to increased real-estate for the ring; and (4) an ability to be assembled without elaborate fixturing or bonding; while not compromising its structural and modal stability.

### BACKGROUND

Vibrating shafts have torsional vibrations inherent due to their non-uniform construction (e.g. crankshafts, and camshafts), or the nature of the driving mechanism employed (e.g. firing order of an internal combustion engine, or gearing), or the method employed for their connection to another shaft (e.g. through a universal, or a constant-velocity joint). These torsional vibrations if left unattended reach a peak amplitude when their exciting frequency approaches the natural torsional frequency of the shaft; this phenomenon is called resonance, and can cause premature fatigue failure of the shaft, or can be felt as undesirable noise or vibration by a vehicle or machine operator.

Torsional Vibration Dampers (TVDs) are commonly employed to attenuate such undesirable vibrations. The objective of a TVD is break the vibratory amplitude peak at resonance to two (or more) smaller peaks which have sufficiently reduced amplitudes that can be sustained by the shaft.

With size reduction being a prime prerogative for design of almost all vehicle, engine, and driveline manufacturers, getting adequate real-estate for packaging the TVD is a challenge. Furthermore, TVD manufactures are under constant pressure for manufacturing devices that are more cost, and weight effective. There is a strong demand for a TVDs with: (1) a reduced volume of elastomer; (2) a narrower axial thickness; (3) enhanced performance due to increased real-estate for the ring; and (4) an ability to be assembled without elaborate fixturing; while not compromising its structural and modal stability thereof. The disclosed invention specifically addresses these needs.

### SUMMARY OF INVENTION

TVDs usually comprise of two concentric metallic components that define an axis-symmetric space namely the profile between them. It is within this profile that an elastomer element is inserted. Two parameters define the profile: (1) a “width” measured axially, and (2) a “gap” measured radially. Furthermore, the Width/Gap Ratio (WGR) of a TVD is also an important design consideration and is usually maintained between set design thresholds.

Due to limitations in the manufacturing methods utilized, the gap has a lower dimensional limit, thus the resulting width also has a corresponding lower limit to ensure the maintenance of the WGR above its lower limit. The effect of these two lower limits compounds to yield a much larger than required elastomer volume. The present invention teaches a TVD that has a smaller gap and width that work in tandem to reduce the volume of elastomer used along with several other advantages. Furthermore, a novel method of assembly unique to the invention is also disclosed. This invention and the method of assembly thereof may be further appreciated considering the following detailed description and drawings in which:

### BRIEF DESCRIPTION OF THE DRAWINGS

FIG. 1 is a partial cross-section illustrating the structure of a conventional TVD.

FIG. 2 is a partial cross-section illustrating an embodiment of the invention where the elastomer is guided and received by two ledges that allow a partial axial opening.

FIG. 3 is a partial cross-section of an assembly process (before assembly has occurred) that is commonly employed to manufacture a conventional TVD.

FIG. 4 is a partial cross-section of an assembly process (after assembly has occurred) that is commonly employed to manufacture a conventional TVD.

FIG. 5 is a partial cross-section of the novel method of assembly that is suggested for producing the invention.

FIG. 6 is a partial cross-section illustrating another embodiment of the invention where the elastomer is guided and received by two ledges that do not allow a partial axial opening on one or both sides.

FIG. 7 is a partial cross-section illustrating another embodiment of the invention where the position of the hub and ring are reversed, thereby yielding an internal inertia TVD.

FIG. 8 is a partial cross-section illustrating another embodiment of the invention where the elastomer is only guided into position by the ring thereby allowing a construction where the shaft itself acts as an internal pseudo-hub.

FIG. 9 is a partial cross-section illustrating another embodiment of the invention where the elastomer is only guided into position by the ring thereby allowing a construction where the shaft itself acts as an external pseudo-hub.

### DETAILED DESCRIPTION

The present invention discloses that by employing a novel product idea coupled with a novel method of assembly that promotes four advantages over conventional TVDs: (1) a reduced volume of elastomer; (2) a narrower axial thickness; (3) enhanced performance due to increased real-estate for the ring; and (4) an ability to be assembled without elaborate fixturing or bonding; while not compromising its structural and modal stability.

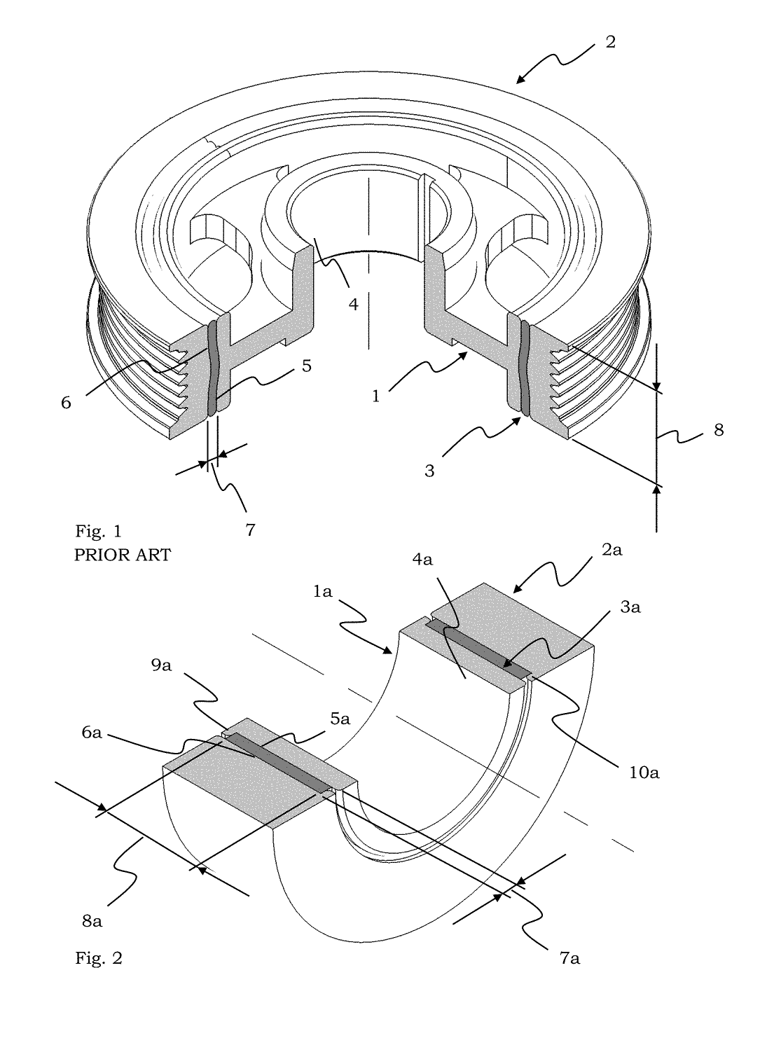

FIG. 1 illustrates a simple conventional TVD that includes an inner rigid structural bracket namely the hub 1; an outer active inertial component namely the ring 2; and an elastomer 3 (in ring or strip form) that is press-fitted between hub 1 and ring 2. Hub 1 connects the TVD to the vibrating shaft via the central cylindrical surface namely the bore 4. Furthermore, hub 1 includes an outer peripheral axis-symmetric surface 5 that receives the inner-diameter of elastomer 3. Ring 2 similarly includes an inner peripheral axis-symmetric surface 6 that receives the outer-diameter of elastomer 3.

Hub 1, and ring 3 of a TVD are generally constructed from a rigid material, including but not limited to gray-cast-iron, nodular-iron, steel, aluminum, or a composite material. Elastomer 3 is generally constructed from a natural or synthetic polymer including but not limited to, Styrene Butadiene Rubber (SBR), Ethylene Propylene Diene Monomer (EPDM), or Poly Butadiene Rubber (PBD).

Axis-symmetric surfaces 5 and 6 are parallel to each other through their axial length. The space between axis-symmetric surfaces 5 and 6 where elastomer 3 resides may either be rectangular or wavy in cross-section and is defined by two parameters namely a gap 7 that is the radial distance between surfaces 5 and 6, and a width 8 which is the axial length of surfaces 5 and 6. Gap 7 and width 8 effectively define the assembled state of elastomer 3. Elastomer 3 is usually compressed between 25% to 45% of its original thickness, therefore gap 7 is 25% to 45% smaller than the radial thickness of elastomer 3 in its uncompressed state; correspondingly, width 8 is 25% to 45% larger than the axial width of elastomer 3 in its uncompressed state.

The Width/Gap Ratio (WGR) of a TVD is an important design consideration and is usually maintained between set thresholds of six (6) to twenty (20). Usually, a smaller than six (6) WGR causes modal and structural instability in the TVD, while a larger than twenty (20) WGR causes assembly problems.

Modal instability refers to the TVD's inability to meet the three-pronged modal criteria for design: (1) the first mode of vibration is torsional in nature; (2) the second mode must be adequately separated from the first mode (by at least 20 Hz); and (3) the elastomer's dynamic-shear-modulus must be within the feasible range for manufacture (approximately between 0.5 to 5.0 MPa).

Structural instability refers to the TVDs inability to: (1) resist slippage along the metal-to-elastomer interfaces 5 and 6 (slip-torque capacity); (2) undertake shear-strain at resonance; (3) undertake shear-stress during resonance; and (4) dissipate vibratory energy as heat without self-destructing.

Assembly problems refer to a wavy condition of the elastomer on its axial periphery due to frictional stick-slip between elastomer 3 and metallic surfaces 5 and 6 belonging to hub 1 and ring 2 respectively during assembly. Generally, this is caused if the assembly fluid (usually a naphthenic oil) is wiped off the elastomer metal interface due to a “squeegee” like effect, and the bare metal on elastomer does not promote a smooth laminar flow. This condition causes a part reject as there usually exists a print callout for the maximum allowable axial protrusion and/or recess of elastomer 3 from hub 1 and ring 2.

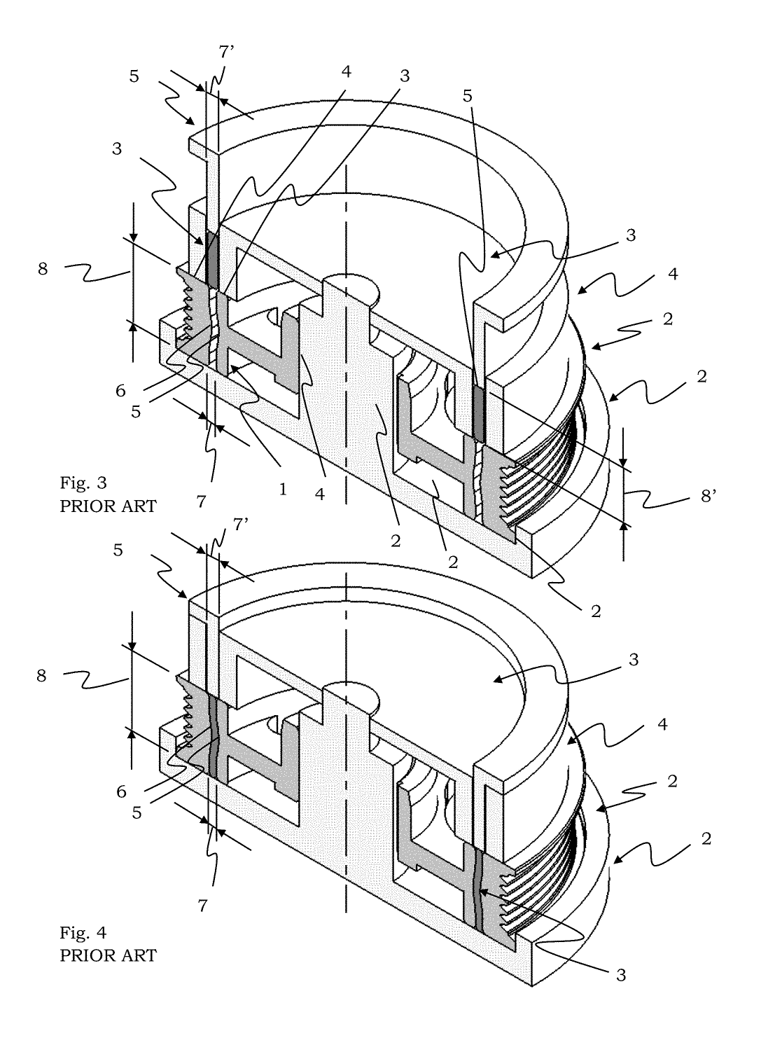

FIG. 2 illustrates an embodiment of the invention that comprises of hub 1a, ring 2a, and elastomer 3a. Hub 1a and ring 2a have been simplified from those represented in 1 and 2 in FIG. 1 for clarity. Depending upon the application, hub 1a and ring 2a can have the same level of complexity as their counterparts in 1 and 2 in FIG. 1. However, in the invention, hub 1a has a novel added feature namely the receiving-ledge 9a, and ring 2a has a novel added feature namely the guiding-ledge 10a.

Receiving-ledge 9a comprises of a cylindrical surface that is concentric to cylindrical surface 5a, but displaced radially outward, and is axially bounded by two annular surfaces. Similarly, the guiding-ledge 10a comprises of a cylindrical surface that is concentric to cylindrical surface 6a, but displaced radially inward, and is axially bounded by two annular surfaces.

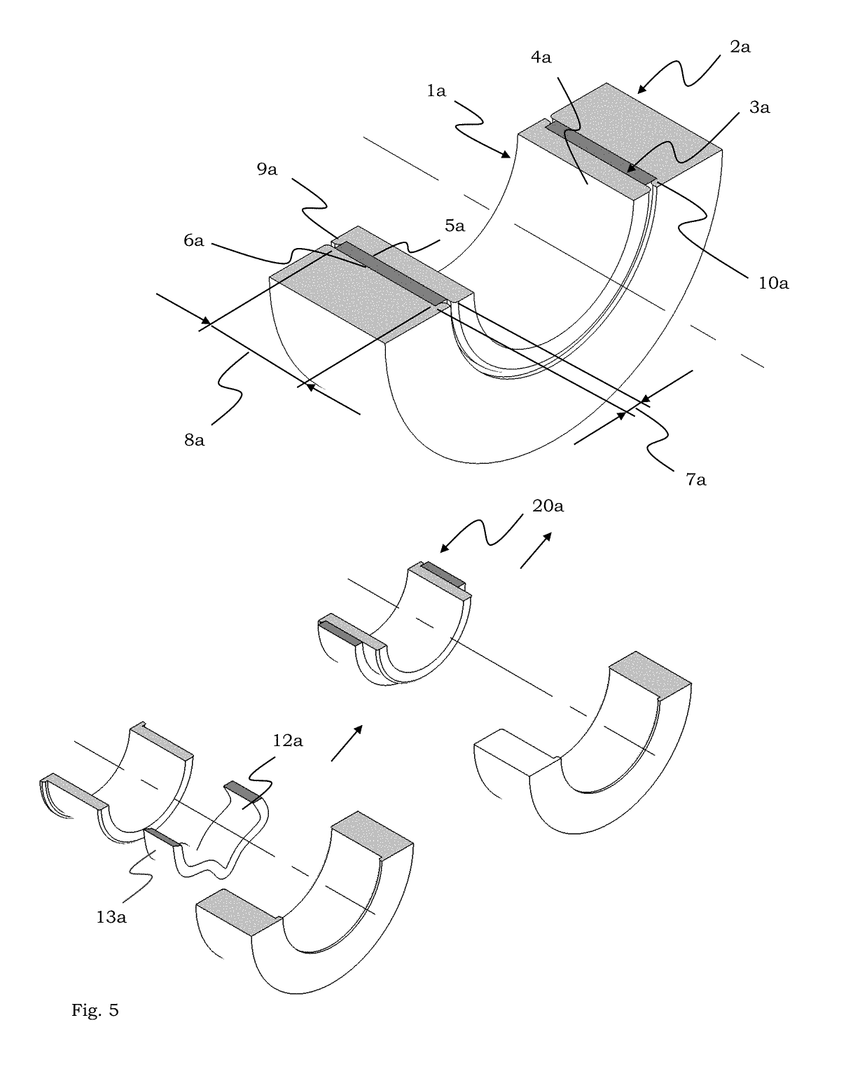

Both receiving-ledge 9a and guiding-ledge 10a can have varying geometry in so long as they cover between 10% and 100% of elastomer 3a along the axial periphery. Also, it must be appreciated that the receiving-ledge 9a and guiding-ledge 10a may not be axis-symmetric, but may have periodically appearing features if they serve their purpose. Also, receiving-ledge 9a and guiding-ledge 10a are not required to be concentric if they serve their purpose. The purpose of receiving-ledge 9a is to axially retain elastomer 3a in position during assembly (illustrated in FIG. 5), while the purpose of guiding-ledge 10a is to axially push elastomer 3a in position during assembly (illustrated in FIGS. 3 and 4).

Elastomer 3a is tubular in its uninstalled position, and is radially received on its inner-diameter by the cylindrical surface of hub 5a, and on its outer-diameter by the cylindrical surface of ring 6a. Elastomer 3a has a reduced volume compared to its counterpart 3 in FIG. 1, as the dimensions of the space between cylindrical surfaces 5a and 6a namely the gap 7a is reduced. Consequently, the axial length of the cylindrical surfaces 5a and 6a namely the width 8a can be correspondingly reduced to meet the minimum WGR requirement. This leads to a significant overall volumetric reduction of elastomer 3a. The detailed reasoning for the dimensional reduction of gap 7a will be clarified while comparing the conventional method of assembly (FIGS. 3 and 4) vs. the novel method of assembly (FIG. 5).

FIG. 3 illustrates the setup of a conventional TVD in the assembly fixture before assembly of elastomer 3 into hub 1 and ring 2. A standard assembly fixture includes a base-plate 20, an inner-guide 30, an outer-guide 40, and a blade 50. Hub 1 and ring 2 rest on the horizontal annular surface 22 of base-plate 20. Hub 1 is piloted radially on post 21 of base-plate 20 along its central bore 4 and ring 2 is piloted radially on the cylindrical inner-diametric surface 23 of the flanged portion of base-plate 20.

The horizontal annular surface 41 of outer-guide 40, and horizontal annular surface 31 of inner-guide 30 rest on ring 2 and hub 1 respectively. Elastomer 3 is placed in the space defined by the cylindrical inner-diametric surface of the outer-guide and the cylindrical outer-diametric of the inner-guide with dimension 7′. Blade 50 rests on its annular surface 51 on top of elastomer 3. Blade 50 and elastomer 3 are both piloted radially between inner-guide 30 and outer-guide 40.

The radial gap between axis-symmetric surface 5 and the axis-symmetric surface 6 has a dimension of 7. Elastomer 3 is compressed between 25% and 45% thereby making dimension 7 larger than dimension 7′ by the same amount. Also, the axial lengths of the axis-symmetric surfaces 5 and 6 have a dimension of 8 that is larger than width 8′ of elastomer 3 before assembly.

FIG. 4 illustrates the completed assembly process of the TVD, when blade 50 is forced axially downward thereby compressing elastomer 3 between the axis-symmetric surface 5 and the axis-symmetric surface 6. This effectively changes the radial thickness of elastomer 3 from 7′ to 7 (a 25% to 45% reduction), and the axial width of elastomer 3 from 8 to 8′ (a 25 to 45% increase). The axial compression of elastomer 3, coupled with the resisting friction between the elastomer 3 and metallic surfaces 5 and 6, causes a back pressure on elastomer 3 and blade 50. This effectively requires elastomer 3 to have axial stiffness to prevent buckling during assembly. This is the reason elastomer 3 is necessitated to have a substantial radial wall thickness 7′ before assembly and a corresponding lower limit to dimension 7 after assembly. The WGR limit requirement forces dimension 8 to have a similar lower limit. This requirement forces the volume of elastomer 3 to be substantially larger than required to avoid assembly problems.

FIG. 5 illustrates a novel method of assembly that can be employed to produce the invention that allows the use of a very thin-walled elastomer 3a, and eliminates the need for an assembly fixture as illustrated in FIGS. 3 and 4. The progression of the assembly process is indicated by the arrows (bottom-left to the top-right of the page).

Thin-walled elastomer 3a starts off as a flexible (axially and radially compliant) band that has an inner-surface 12a and an outer-surface 13a. The circumferential length of inner-surface 12a by design is smaller than the circumferential length of cylindrical surface 5a. Elastomer 3a is essentially stretched and mounted on hub 1a such that it is received radially by cylindrical surface 5a, and axially by receiving-ledge 9a thereby forming sub-assembly 20a. The fact that elastomer 3a is axially and radially supported by hub 1a allows elastomer 3a to have a very thin cross-section.

Ring 2a has a cylindrical surface 6a which by design is smaller diametrically than the cylindrical surface 13a in the sub-assembled condition of 20a. Furthermore, the tubular volume bounded axially by receiving-ledge 9a and guiding-ledge 10a, and bounded radially by cylindrical surfaces 5a and 6a is by design larger than the volume of elastomer 3a. This excess space provides relief for the manufacturing tolerance of elastomer 3a to ensure that there is no axial pressure exerted by elastomer 3a on hub 1a or ring 2a. The goal is to compress the elastomer between 10% to 50% such that it provides proper structural stability to the TVD. Ring 2a is guided over surface 13a by means of a simple press (without an elaborate assembly fixture), because the TVD in effect partially assumes the role of the assembly fixture. Guiding-ledge 10a enables axial containment of the elastomer 3a between hub 1a and ring 2a.

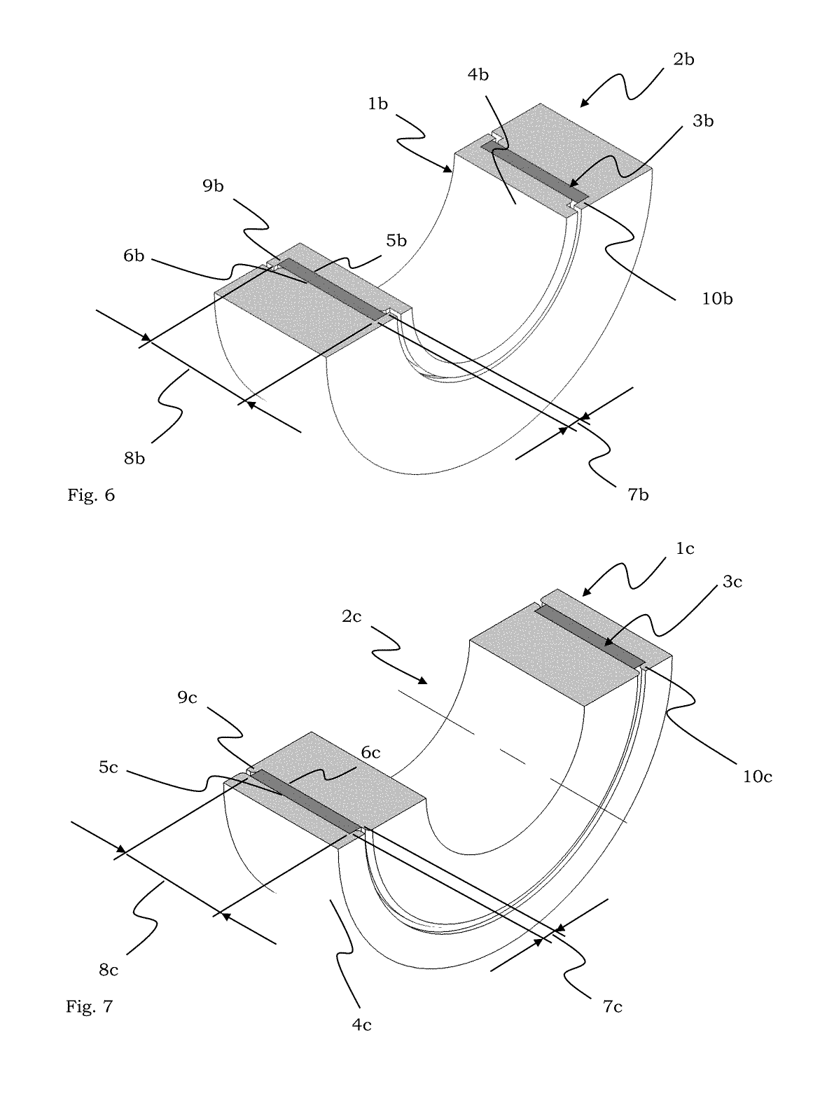

FIG. 6 illustrates another embodiment of the invention where receiving-ledge 9b extends radially past elastomer 3b in the uninstalled position with a corresponding feature machined off the ring 2b to accommodate receiving-ledge 9b such that hub 1b and ring 2b don't contact each other.

Similarly, guiding-ledge 10b on ring 2b extends radially past elastomer 3b in the uninstalled position with a corresponding feature machined off the hub 1b to accommodate the guiding-ledge 10b such that hub 1b and ring 2b don't contact each other. It must be appreciated that either one or both the ledges may extend radially past elastomer 3b.

Construction of this embodiment adds additional machining to hub 1b and ring 2b but yields two advantages: (1) it allows elastomer 3b to be encapsulated axially and be better protected from contaminants entering the TVD, and (2) it enables better support via the extended ledges 9b and 10b to receive and guide the elastomer 3b respectively thereby ensuring a more robust assembly process.

FIG. 7 illustrates another embodiment of the invention where hub 1c is external to ring 2c thereby constituting an internal inertia design. Here ring 2c bears the receiving-ledge 9c, and hub 1c bears the guiding-ledge 10c. This effectively reverses the order of assembly of the TVD, in that elastomer 3c first gets stretched and mounted on the cylindrical surface 6c, then hub 1c gets pushed on over the sub-assembly contacting the cylindrical surface 5c with elastomer 3c.

The construction of this embodiment does not allow for the most effective use of the inertia in ring 2c as the center of gyration of ring 2c decreases for granting hub 1c the necessary real-estate in the outermost periphery of the packaging zone. However, there are applications where the poly-vee grooves (not shown) are located on hub 1c as opposed to ring 2c to necessitate a rigid path for the power flow from the crankshaft to the Front End Accessory Drive (FEAD) (e.g. belt start generating systems employed for start-stop applications). This embodiment allows the construction of TVDs for such applications.

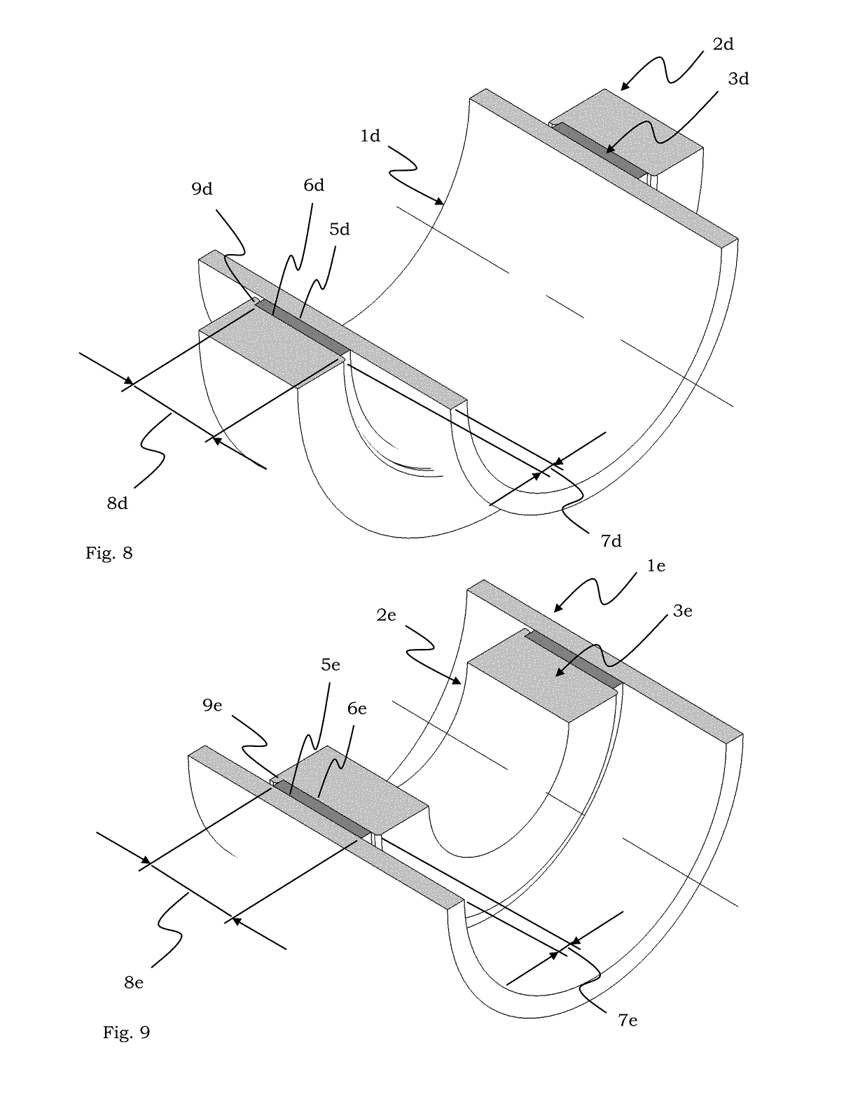

FIG. 8 illustrates another embodiment of the invention that employs the use of only one ledge—the guiding-ledge 9d. The resulting TVD is one where the traditional hub is replaced by a tube, flange or even a solid vibrating shaft 1d, and ring 2d is external to the vibrating shaft 1d. This construction is commonly called Outside the Tube Damper (OTD). Vehicle drivelines generally require such a construction due to limited packaging space. Vibrating shaft 1d itself becomes a pseudo-hub. It must also be appreciated that for the OTD to be effective it needs to be mounted at an axial location on the vibrating shaft 1d (at a modal antinode).

The first step of the assembly process is to stretch and mount elastomer 3d circumferentially onto cylindrical surface 5d of vibrating shaft 1d. Next, ring 2d is guided along its inner cylindrical surface 6d axially and radially onto elastomer 3d until guiding-ledge 9d comes into planar axial contact with elastomer 3d. The guiding-ledge 9d then guides/pushes ring 2d and elastomer 3d to the desired axial location on the vibrating shaft 1d.

FIG. 9 illustrates another embodiment of the invention that employs the use of only one ledge—the guiding-ledge 9e. The resulting TVD is one where the traditional hub is replaced by a tube, flange or even a solid vibrating shaft 1e, and ring 2e is internal to the vibrating shaft 1e. This construction is commonly called Inside the Tube Damper (ITD). Vehicle drivelines generally require such a construction due to limited packaging space. Vibrating shaft 1e itself becomes a pseudo-hub. It must also be appreciated that for the ITD to be effective it needs to be mounted at an axial location on vibrating shaft 1e (at a modal antinode).

The first step of the assembly process is to stretch and mount elastomer 3e circumferentially onto cylindrical surface 5e of ring 2e. Next, vibrating shaft 1e is guided along its inner cylindrical surface 5e axially and radially onto elastomer 3e until guiding-ledge 9e comes into planar axial contact with elastomer 3e. The guiding-ledge 9e then guides/pushes ring 2e and elastomer 3e onto the desired axial location on vibrating shaft 1e.

The invention claimed is:

1. A Torsional Vibration Damper (TVD) that uses a reduced volume of elastomer and eliminates the need for an assembly fixture or bonding by virtue its construction, comprising:
a hub that is bounded on its radially distal extremity by a first cylindrical surface defined by its outer diameter comprising a receiving-ledge including
a second cylindrical surface that shares the same central axis with the first cylindrical surface but is displaced radially outward;
a first outer annular surface that bounds the second cylindrical surface axially;
a second inner annular surface opposing the first outer annular surface that bounds the second cylindrical surface axially;
a ring that is bounded on its radially proximal extremity by a first cylindrical surface defined by its inner diameter comprising a guiding-ledge including
a second cylindrical surface that shares the same central axis with the first cylindrical surface but is displaced radially inward;
a first outer annular surface that bounds the second cylindrical surface axially;
a second inner annular surface opposing the first annular surface that bounds the second cylindrical surface axially;
an elastomer band that
is first stretched and mounted on the hub received radially by the first cylindrical surface of the hub, and axially by the second inner annular surface of the receiving ledge;
is next compressed by the first cylindrical surface of the ring, and axially by the second inner annular surface of the guiding ledge;
in its final position of assembly, occupies the axis-symmetric channel bounded radially by the first cylindrical surface of the hub, the first cylindrical surface of the ring, and partially axially bounded by the second inner annular surface of the receiving ledge, and the second inner annular surface of the guiding ledge wherein
the resulting TVD has less than 100% of the elastomer area covered by the second inner annular surface of the receiving ledge on one axial periphery, and less than 100% of the elastomer area covered by the second inner annular surface of the guiding ledge on the opposite axial periphery.

2. The TVD defined by claim 1 wherein the TVD has 100% of the elastomer area covered by the second inner annular surface of the receiving ledge on one axial periphery, and less than 100% of the elastomer area covered by the second inner annular surface of the guiding ledge on the opposite axial periphery.

3. The TVD defined by claim 1 wherein the TVD has less than 100% of the elastomer area covered by the second inner annular surface of the receiving ledge on one axial periphery, and 100% of the elastomer area covered by the second inner annular surface of the guiding ledge on the opposite axial periphery.

4. The TVD defined by claim 1 wherein the TVD has 100% of the elastomer area covered by the second inner annular surface of the receiving ledge on one axial periphery, and has 100% of the elastomer area covered by the second inner annular surface of the guiding ledge on the opposite axial periphery.

5. The TVD defined by claim 1 wherein the receiving ledge and the guiding ledge are not axis-symmetric in construction, but have periodic features that enable them to perform their respective functions.

6. The TVD defined by claim 1 wherein the receiving ledge and the guiding ledge do not share the same axis as the first cylindrical surface of the hub, or the first cylindrical surface of the ring.

7. The TVD defined in claim 1 wherein the positions of the hub and ring are reversed radially such that the hub in internal to the ring, the receiving ledge resides on the ring, and the guiding ledge resides on the hub; furthermore, the order of assembly also reverses in that the elastomer band is first stretched and mounted on the ring received radially by the first cylindrical surface of the ring, and axially by the second inner annular surface of the receiving ledge; next, the elastomer is compressed by the first cylindrical surface of the hub, and axially by the second inner annular surface of the guiding ledge.

8. A Torsional Vibration Damper (TVD) that uses a reduced volume of elastomer and eliminates the need for an assembly fixture or bonding by virtue its construction, comprising:
a vibrating structure (pseudo hub) that is bounded on its radially distal extremity by a first cylindrical surface defined by its outer diameter a ring that is bounded on its radially proximal extremity by a first cylindrical surface defined by its inner diameter comprising a guiding-ledge including
a second cylindrical surface that shares the same central axis with the first cylindrical surface but is displaced radially inward;
a first outer annular surface that bounds the second cylindrical surface axially;
a second inner annular surface opposing the first annular surface that bounds the second cylindrical surface axially;
an elastomer band that
is first stretched and mounted on the pseudo hub received radially by the first cylindrical surface of the pseudo hub;
is next compressed and moved into position by the cylindrical surface defined by the inner diameter of the ring, and axially by the second inner annular surface of the guiding ledge;
in its final position of assembly occupies the partial channel bounded radially by the first cylindrical surface of the hub, the first cylindrical surface of the ring, and axially by the second inner annular surface of the guiding ledge wherein
the resulting TVD has less than 100% of the elastomer area covered by the second inner annular surface of the guiding ledge on one axial periphery.

9. The TVD defined by claim 8 the positions of the hub and ring are reversed radially such that the hub in internal to the ring; furthermore, the order of assembly also reverses in that the elastomer band is first stretched and mounted on the pseudo hub received radially by the first cylindrical surface of the pseudo hub; next, the elastomer is compressed by the first cylindrical surface of the ring, and axially by the second inner annular surface of the guiding ledge.
